(19) United States
(12) Patent Application Publication
(10) Pub. No.: US 2010/0125621 A1
(43) Pub. Date: May 20, 2010

(54) ARITHMETIC PROCESSING DEVICE AND METHODS THEREOF

(75) Inventors: David S. Oliver, Longmont, CO (US); Debjit Das Sarma, San Jose, CA (US); Scott Hilker, Campbell, CA (US)

Correspondence Address: LARSON NEWMAN & ABEL, LLP, 5914 WEST COURTYARD DRIVE, SUITE 200, AUSTIN, TX, 78730, US

(73) Assignee: Advanced Micro Devices, Inc., Sunnyvale, CA (US)

(21) Appl. No.: 12/274,996

(22) Filed: Nov. 20, 2008

(51) Int. Cl. G06F 7/52

(52) U.S. Cl. 708/620

(57) ABSTRACT

An arithmetic processing unit is disclosed that can perform multiply operations, addition operations, or a combination thereof. The arithmetic processing unit can operate in two modes. The first mode supports one single, double, or extended-precision computation, and the second mode supports two simultaneous single-precision computations using the same exponent and mantissa datapaths.

### BACKGROUND

1. Field of the Disclosure

The present disclosure relates generally to data processing devices, and more particularly to arithmetic processing devices.

2. Description of the Related Art

A data processor device may include a specialized arithmetic processing unit such as an integer or floating-point processing device. Floating-point arithmetic is particularly applicable for performing tasks such as graphics processing, digital signal processing, and scientific applications. A floating-point processing device generally includes devices dedicated to specific functions such as multiplication, division, and addition for floating point numbers.

A floating-point processing device typically supports arithmetic operations for one or more number formats, such as single-precision, double-precision, and extended-precision formats. In addition, some floating point devices support instruction sets that provide for multiple arithmetic operations per instruction. For example, “Single Instruction, Multiple Data” (SIMD) instructions can specify that the same mathematical operation be performed on multiple data elements

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating an arithmetic processing unit in accordance with a specific embodiment of the present disclosure.

FIG. 2 is a block diagram illustrating the arithmetic processing unit of FIG. 1 operating in a second mode in accordance with a specific embodiment of the present disclosure.

FIG. 3 is a block diagram illustrating a portion of a multiply-addition module of the arithmetic processing unit of FIG. 1 configured to operate in the first mode in accordance with a specific embodiment of the present disclosure.

FIG. 4 is a block diagram illustrating a portion of a multiply-addition module of the arithmetic processing unit of FIG. 2 configured to operate in a second mode in accordance with a specific embodiment of the present disclosure.

FIG. 5 is a flow diagram illustrating a method in accordance with a specific embodiment of the present disclosure.

The use of the same reference symbols in different drawings indicates similar or identical items.

### DETAILED DESCRIPTION

An arithmetic processing unit is disclosed that can perform multiply operations, addition operations, or a combination thereof. The arithmetic processing unit can operate in two modes. The first mode supports one single, double, or extended-precision computation, and the second mode supports two simultaneous single-precision computations using the same exponent and mantissa datapaths.

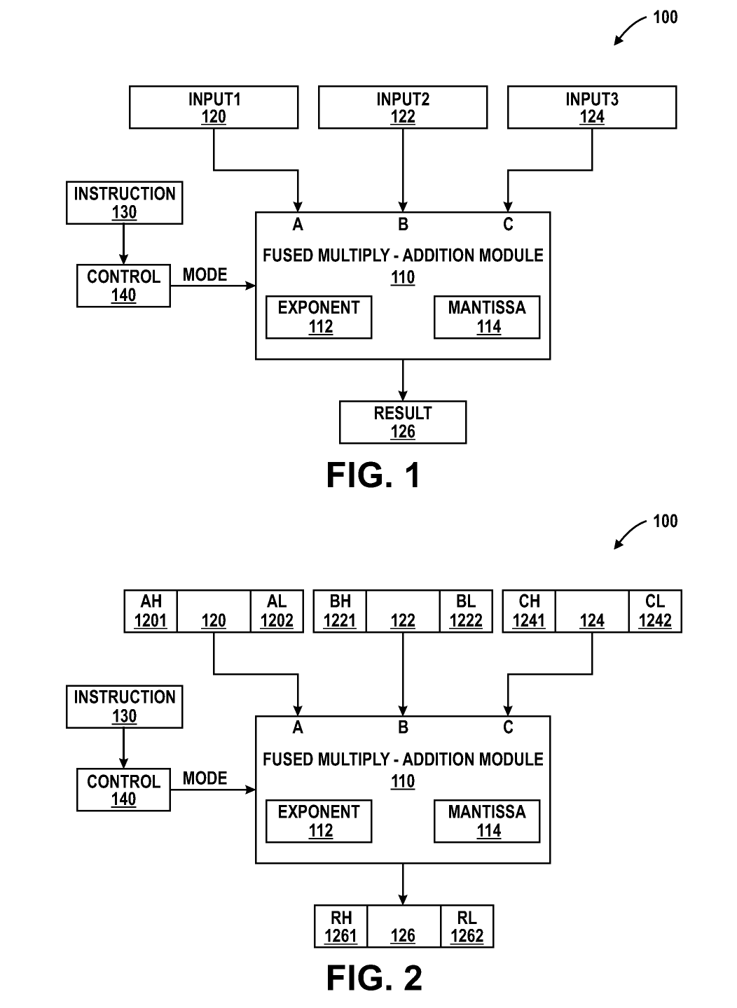

FIG. 1 is a block diagram illustrating an arithmetic processing unit 100 in accordance with a specific embodiment of the present disclosure. Arithmetic processing unit 100 includes a fused multiply-addition module (FMAM) 110, operand registers 120, 122, and 124, result register 126, an instruction register 130, and a control module 140. FMAM 110 further includes exponent module 112 and mantissa module 114.

FMAM 110 has an input labeled “A” connected to operand register 120, an input labeled “B” connected to operand register 122, an input labeled “C” connected to operand register 124, an input to receive a signal labeled “MODE,” from control module 140, and an output to provide a result to register 126. Control module 140 has an input to receive an instruction from instruction register 130.

FMAM 110 is an arithmetic processing device that can execute arithmetic instructions such as multiply, add, subtract, multiply-add, and multiply-accumulate instructions. FMAM 110 can receive three inputs, A, B, and C. Inputs A and B are a multiplicand and a multiplier, respectively, and input C is an addend. To execute a multiply-add instruction, such as floating-point multiply-add (FMADD), operands A (INPUT1) and B (INPUT2) are multiplied together to provide a product, and operand C is added to the product. A multiply instruction, such as a floating-point add (FMUL), is executed in substantially the same way except operand C (INPUT3) is set to a value of zero. An add instruction, such as a floating-point add (FADD) is executed in substantially the same way except operand B is set to a value of one. FMAM 110 includes an output to provide a result of the instruction to result register 126.

In the illustrated embodiment of FIG. 1, it is assumed that FMAM 110 is implemented as a pipelined datapath and is compliant with IEEE-754 floating-point standards. FMAM 110 can perform extended, double, and single-precision operations, and can also perform two single-precision operations in parallel using a “packed single” format. A floating-point number includes a significand (mantissa) and an exponent. For example, the floating-point number 1.1011010*2¹⁵ has a significand of 1.1011010 and an exponent of 15.

The most significant bit of the mantissa, to the left of the binary point, is referred to as an “implicit bit.” A floating-point number is generally presented as a normalized number, where the implicit bit is a one. For example, the number 0.001011*2²³ can be normalized to 1.011*2²⁰ by shifting the mantissa to the left until a “1” is shifted into the implicit bit, and decrementing the exponent by the same amount that the mantissa was shifted. A floating-point number will also include a sign bit that identifies the number as a positive or negative number. The exponent can also represent a positive or negative number, but a bias value is added to the exponent so that no exponent sign bit is required.

For purposes of discussion, it is assumed that the fractional component of the mantissa of a single-precision number has twenty-four bits of precision, a double-precision number has fifty-three bits of precision, and an extended-precision number has 64 bits of precision. A packed single format contains two individual single-precision values. The first, (low) value includes a twenty-four bit mantissa that is right justified in the 64-bit operand field, and the second (high) value includes another twenty-four bit mantissa that is left justified in the 64-bit operand field, with sixteen zeros included between the two single-precision values.

FMAM 110 includes mantissa module 114 that performs mathematical operations on the mantissa of the received operands( ) and includes exponent module 112 that performs mathematical operations on the exponent ( ) portions of the floating-point operands. Mantissa module 114 and exponent module 114 perform their operations in a substantially parallel manner.

In addition, it is assumed for purposes of discussion that FMAM 110 is implemented using a five stage pipeline. During the first pipeline stage, the exponent of the product is calculated, and the multiply operation begins. The multiplier uses a radix-4 booth recoding technique in which the multiplier and multiplicand are used to generate thirty-three partial products. The first two levels of 4:2 compressors in a multiplier carry-save adder (CSA) tree are included in the first pipeline stage. During the second pipeline stage, the exponents of the product and the addend are compared and the larger is selected to provide a preliminary exponent of the result. The second stage also includes the three additional 4-2 compressor levels.

During the third pipeline stage, the intermediate result (sum and carry) of the multiply-add are presented to a carry-propagate adder (CPA), which calculates an un-normalized and unrounded result. In parallel with the CPA, a leading zero anticipator (LZA) operates on the same intermediate result as the CPA to produce controls for normalization. During the fourth pipeline stage, this result is normalized, and during the fifth stage, the normalized result is rounded.

Operand registers 120, 122, and 124 can each contain a data value, INPUT1, INPUT2, and INPUT3, respectively, that can be provided to FMAM 110. For the purposes of discussion, INPUT1, INPUT2, and INPUT3 can be single, double, or extended-precision floating-point numbers or a combination thereof. FMAM 110 can perform the requested arithmetic operation using the data values, and provide a result to result register 126. For example, FMAM 110 can execute a double-precision FMAC instruction where INPUT1 is multiplied by INPUT2, and the product is added to INPUT3. A double-precision result is provided to result register 126.

Instruction register 130 can contain an instruction (also referred to as an operation code and abbreviated as “opcode”), which identifies the instruction that is to be executed by FMAM 110. The opcode specifies not only the arithmetic operation to be performed, but also the precision of the result that is desired.

Control module 140 can receive the instruction from instruction register 130 and provide mode information, via signal MODE, to FMAM 110. For example, control module 140, upon receiving an extended-precision FMUL instruction, can configure FMAM 110 to perform the indicated computation and to provide an extended-precision result. Moreover, signal MODE can configure FMAM 100 to interpret each of input values INPUT1-3 as representing on operand of any of the supported precision modes.

FIG. 2 is a block diagram illustrating the arithmetic processing unit 100 of FIG. 1 operating in a second mode in accordance with a specific embodiment of the present disclosure. In the illustrated example of FIG. 2 operand register 120 further includes portions 1201 and 1202, operand register 122 further includes portions 1221 and 1222, operand register 124 further includes portions 1241 and 1242, and result register 126 further includes portions 1261 and 1262.

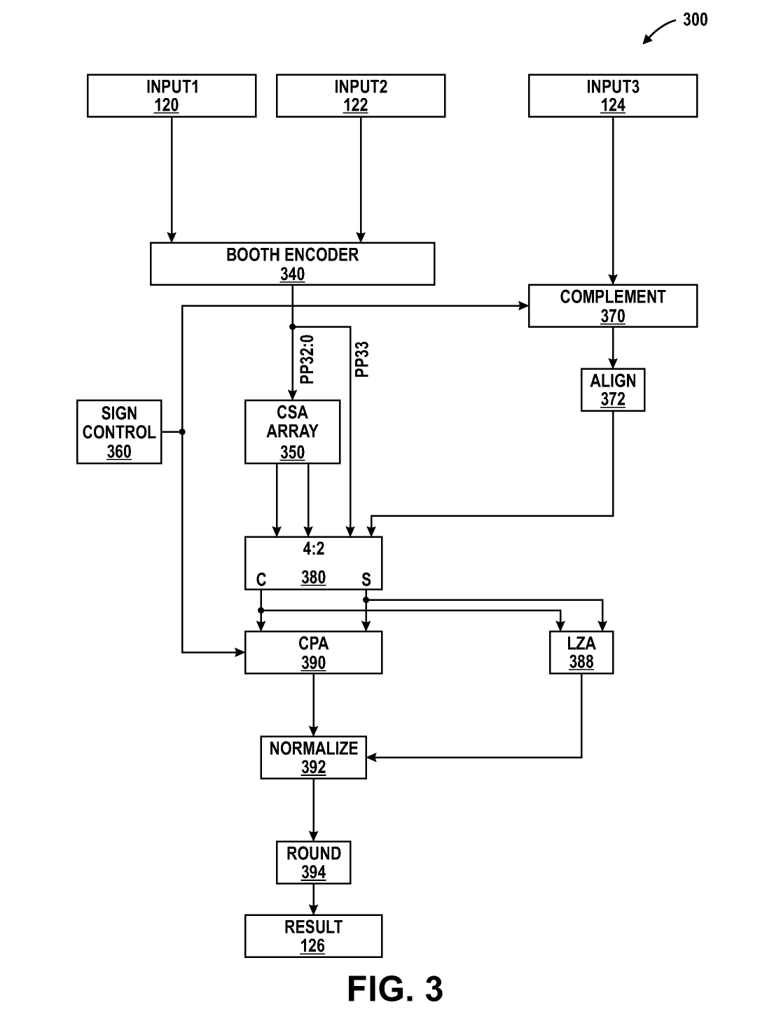

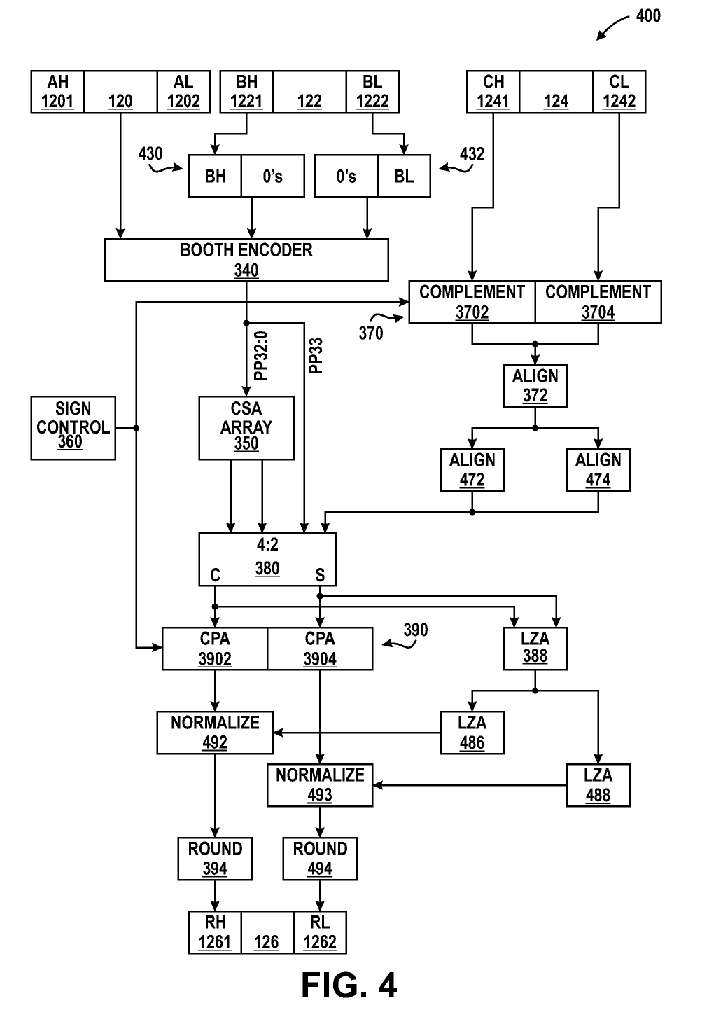

FIG. 2 illustrates arithmetic processing unit 100, and FMAM 110 in particular, operating in a second mode. For the purpose of example, assume that instruction register 130 contains a packed single-precision FMAC opcode. Each input value provided to inputs A, B, and C of FMAM 110 from operand registers 120-124, contains two single-precision operands, a “high” operand and a “low” operand. FMAM 110 can perform the FMAC calculation using the three high operands to provide a high result, (AH*BH)+CH=RH, and simultaneously perform the FMAC calculation using the three low operands to provide a low result (AL*BL)+CL=RL. The operation of FMAM 110 in the normal and packed-single modes can be better understood with reference to FIGS. 3 and 4. FIG. 3 is a block diagram illustrating a portion 300 of arithmetic processing unit of FIG. 2 configured to operate in the normal mode in accordance with a specific embodiment of the present disclosure.

Portion 300 include operand registers 120, 122, and 124, a Booth encoder 340, a CSA array 350, a sign control 360, a complement module 370, an alignment module 372, CSA 380, LZA 388, CPA 390, a normalize module 392, and a round module 394. Operand register 120 further includes portions 1201 and 1202, operand register 122 further includes portions 1221 and 1222, operand register 124 further includes portions 1241 and 1242, and result register 126 further includes portions 1261 and 1262.

Operand register 120 and 122 are connected to Booth encoder 340. Booth encoder 340 is connected to CSA array 350 and to CSA 380. Sign control 360 is connected to CPA 390, and complement module 370. CSA array 350 has two outputs connected to CSA 380, and CSA 380 has two outputs also connected to CPA 390 and to LZA 388. LZA 388 is connected to normalize module 392. CPA 390 is connected to normalize module 392, and normalize module 392 is connected to round module 394. Round module 394 is connected to result register 126. Register 124 is connected to complement module 370. Complement module has an output connected to alignment module 372, and alignment module 372 is connected to CSA 380.

Operand registers 120 provide a multiplicand operand, INPUT1, and register 122 provides a multiplier operand, INPUT2, to Booth encoder 340. Booth encoder 340 uses radix4 Booth recoding to provide thirty-two partial products to CSA array 350, and a thirty-third partial products to CSA 380. CSA array 350 includes 4 levels of 4:2 carry-save adders to reduce the thirty-two partial products to two 128-bit partial products.

Operand register 124 provides an addend operand, INPUT3, to complement module 370. Complement module 370 can perform a bit-wise inversion of INPUT3 if sign control 360 determines that the computation being performed is an “effective subtract.” The determination of whether the computation is an effective subtract depends on the signs of the source operands as well as sign changes specified by the opcode, and determines if the sign of the product and the sign of the addend are different. Any or all of sources INPUT1, INPUT2, and INPUT3 may be negative (sign1, sign2, and sign3), and the opcode may specify inversion of INPUT3 (invert3) or inversion of the product (invertprod). For ADD/SUB instruction types that include two operands,

EffectiveSubtract=sign1⊕sign3⊕invert3

where sign1, and sign3 are the respective sign bits for INPUT1, and INPUT3, and invert3 corresponds to an optional opcode-specified inversion of INPUT3.

For multiply-add and multiply-subtract instruction types,

EffectiveSubtract=sign1⊕sign2⊕sign3⊕invert3⊕invertprod

where sign1,sign2, and sign3 are the respective sign bits for INPUT1, INPUT2, and INPUT3. Invert3 corresponds to an optional opcode-specified inversion of INPUT3, and invertprod corresponds to an optional opcode-specified inversion of the product prior to the addition operation.

Effective subtract does not identify whether the product or the addend should be inverted. Because floating-point is a sign+magnitude number representation, the mantissa should ultimately be positive. The smaller of the addend and the product could be inverted so that the sum of those is always positive. However, the relative size of the addend and product is unknown when sign control 360 determines whether the computation is an effective subtract. Accordingly, INPUT3 is assumed to be smaller and is inverted by complement module 370. CPA 390 is designed so that if the assumption is wrong and the sum would be negative, CPA 390 automatically inverts the sum and returns a positive result. This is accomplished by using a one's complement adder for the CPA, also known as an end-around-carry adder. The sign of the final result is computed separately.

In particular, the sign of the result is calculated by first assuming that INPUT3 is larger, and choosing a preliminary result sign equal to the exclusive-or of sign3 and invert3. In the case of a pure multiply (INPUT1*INPUT2) there is no INPUT3, so the preliminary result sign is equal to the exclusive-or of sign1 and sign2. This preliminary sign will be correct unless the operation is an effective subtract where INPUT3 was in fact smaller, and the adder should not have previously inverted the result. If that case is detected, the sign of the result is flipped during the fourth stage of the pipeline.

Align module 372 is configured to shift the addend so that its value is aligned to corresponding significant bits of the product, as determined by comparing the value of the exponent of INPUT3 to the value of the product exponent determined by exponents of INPUT1 and INPUT2.

CSA 380 is another 4:2 carry-save adder that is configured to add the last two partial products provided by CSA array 350 to the aligned addend from aligner 372 and to the 33^{rd} partial product from the booth encoder 340. The result provided by CSA 380 is in the form of a 194-bit sum and a 130-bit carry.

CPA 390 is a carry-propagate adder that calculates an un-normalized result based on the sum and carry results provided by CSA 380. LZA 388 operates in parallel to CPA 390, and predicts the number of leading zeros that will be present in the result of CPA 390. The un-normalized result is provided to normalize module 392, which normalizes the result to produce an un-rounded result based on the leading zero prediction from LZA 388. This unrounded result is rounded by round module 394, which provides a final rounded result to result register 126. CPA 390, normalize module 392, and round module 394 can provide a carry-out value to the exponent datapath to increment the exponent of the result.

FIG. 4 is a block diagram illustrating a portion 400 of arithmetic processing unit of FIG. 2 configured to operate in the packed-single mode in accordance with a specific embodiment of the present disclosure.

Portion 400 includes operand registers 120, 122, and 124, registers 430 and 432, Booth encoder 340, CSA array 350, sign control 360, complement module 370, alignment modules 372, 472, and 474, CSA 380, CPA 390, normalize modules 492 and 493, and round modules 384 and 494. Complement module further includes portions 3702 and 3704. CPA 390 further includes portions 3902 and 3904. Operand register 120 further includes portions 1201 and 1202, operand register 122 further includes portions 1221 and 1222, operand register 124 further includes portions 1241 and 1242, and result register 126 further includes portions 1261 and 1262.

Operand register 120 is connected to Booth encoder 340. Portion 1221 of operand register 122 is connected to register 430, and portion 1222 of operand register 122 is connected to register 432. Registers 430 and 432 are also connected to Booth encoder 340. Booth encoder 340 is connected to CSA array 350 and to CSA 380. Sign control 360 is also connected to CPA 390, and complement module 370. CSA array 350 has two outputs connected to CSA 380, and CSA 380 has two outputs connected to LZA 388 and to CPA 390. LZA 388 is connected to LZA 486 and LZA 488. CPA 390 has two portions 3902 and 3904. Portion 3902 and LZA 486 are connected to normalize module 492. Portion 3904 and LZA 488 are connected to normalize module 493. Normalize module 492 is connected to round module 394. Round module 394 is connected to portion 1261 of result register 126. Normalize module 493 is connected to round module 494. Round module 494 is connected to portion 1262 of result register 126. Portion 1241 of operand register 124 is connected to portion 3702 of complement module 370, and portion 1242 of operand register 124 is connected to portion 3704 of complement module 370. The outputs of complement module 370 portions 3702 and 3704 are connected to alignment module 372. Alignment module 372 connects to alignment modules 472 and 474. The outputs of alignment modules 472 and 474 are connected to CSA 380.

Portion 400 highlights how the extended precision mantissa datapath illustrated at FIG. 3 is configured to execute two concurrent single precision operations. Generally, seven aspects of the mantissa datapath are affected: 1) Partial product generation (430, 432, 340), 2) addend alignment operation (372, 472, 474), 3) CSA array operation (350), 4) carry-propagate adder operation (390), 5) LZA operation (388, 486, 488), 6) normalization shifter operation (492, 493), and 7) rounder operation (394, 494).

Two variations of the multiplier operands BH and BL, provided by operand register 122, are prepared. Register 430 receives operand BH, and the twenty-four bits of operand BH are left justified in 64-bit register 430, and bits 39:0 of register 430 are set to zero. Register 432 receives operand BL, and the twenty-four bits of operand BL are right justified in 64-bit register 432, and bits 63:24 of register 433 are set to zero. Booth encoder 340 uses register 432 to calculate 12 least significant partial products, and uses register 430 to calculate 13 most significant partial products. The middle eight partial products can be calculated using the value provided by either register 430 or 432.

Align module 372 is used to perform a fine-grained shift of shift by zero to 15. In this second mode of operation the upper and lower bits of the shifter are controlled independently. Align modules 472 and 474 are dedicated for use in the packed-single mode of operation and complete the shift by performing shifts by multiples of 16. Individual alignment controls are provided by the exponent data path. The exponent datapath is configured in the second mode of operation to provide an alignment shift amount for CH and CL based upon a comparison of the exponents of operands AL, BL, and CL, and AH, BH, and CH, respectively, using the same exponent modules used to provide an alignment shift amount in the first operating mode.

A carry into the least significant bit of CPA 390 is introduced when portion 300 is operating in the first mode if the operation is an effective subtract. When CPA 390 is operating in the second mode, a carry into either or both of portions 3902 and 3904 may be performed based on whether either or both operations, respectively, is an effective subtract. Therefore, sign control 360 can specify that a carry is to be injected not only into bit zero, the least significant bit of portion 3902, but also into bit eighty, the least significant bit of portion 3904, during the carry-propagate calculation.

In the event that a carry is injected into bit 80 of CPA 390, then the natural carry out of bit seventy-nine will not propagate into bit 80. When operating on two packed single-precision operands in the second operating mode, the carry-save adder Wallace tree (CSA array 350 and CSA 380) will always result in a value of one being naturally carried out of bit seventy-nine of CPA 390. Because this natural carry does not occur in CPA 390 when in the second operating mode, a compensation operation is performed during computation of the product by adding a one at bit eighty to the product within CSA array 350, as specified by being in the second operating mode.

LZA module 388 generally comprises two basic steps: generation of a leading zero value, and priority encoding of that value to find the bit position of the first “1”. When in the second operating mode, the first step of generating the LZA value is performed by LZA module 388. The upper portion of that LZA value, corresponding to the high result, is passed to LZA module 486 for priority encoding. The lower portion of the LZA value, corresponding to the low result, is passed to LZA module 488 for priority encoding.

Normalize module 492 receives the unnormalized and unrounded high result from portion 3902 of CPA 390. It also receives the leading zero prediction from LZA 486. It passes the normalized result out to round module 394. Normalize module 493 receives the unnormalized and unrounded low result from portion 3904 of CPA 390. It also receives the leading zero prediction from LZA 488. It passes the normalized result out to round module 494. Note that normalize module 392 is not used in the second mode of operation.

Round module 394 is shared between the first and second modes of operation. When operating in the second mode, round module 394 performs rounding on the high single value and passes the final rounded result to portion 1261 of result register 126. A second round module, 494, is provided to perform the rounding operation on the lower single value when operating in the second mode. The result from round module 494 is placed in portion 1262 of result register 126.

In addition to the mantissa datapath shown in FIG. 4, there is a parallel datapath to compute the exponent. Each register and operator in that datapath is divided into two portions when operating in the second mode of operation: a high portion corresponding to the “high” result and a low portion corresponding to the “low” result. For instance, a carry-out of either or both of the high and low mantissa results can occur during the operation of round modules 394 and 494. Both the high portion and the low portion of the result exponent can be independently incremented appropriately. The same exponent increment modules are used to support operation in the first and second mode.

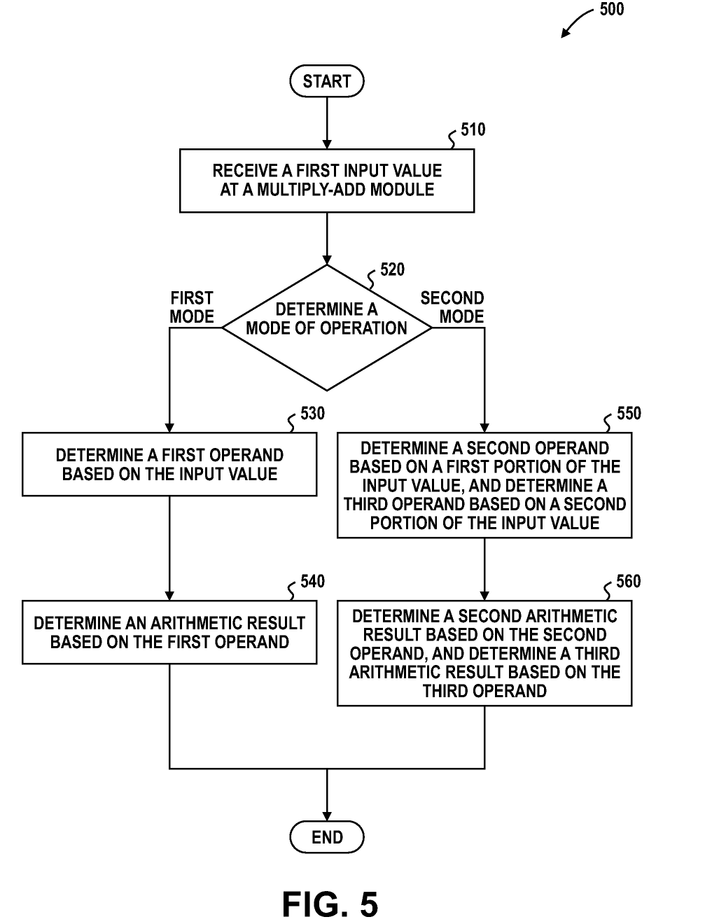

FIG. 5 is a flow diagram illustrating a method in accordance with a specific embodiment of the present disclosure. At block 510, a first input value, such as INPUT1 at FIG. 1, is received at a multiply-add module. At decision block 520, it is determined whether FMAM 100 should operate in a first mode or a second mode. For example, if the instruction provided at instruction register 130 specifies a double precision multiply operation, FMAM 100 will operate in the first mode and the flow diagram proceeds to block 530. At block 530, a first operand is determined based on the input value. Each input value represents a single operand when FMAM 110 is operating in the first mode of operation. At block 540, an arithmetic result is determined based on the first operand, and the result can be provided to result register 126 at FIG. 1.

If the instruction provided at instruction register 130 instead specifies a packed single-precision multiply operation, FMAM 100 will operate in the second mode and the flow diagram proceeds from block 510 to block 550. At block 550, a second operand and a third operand, such as operand AH and AL at FIG. 2, are determined based on the input value contained in operand register 120. Each input value represents two individual single-precision operands when FMAM 110 is operating in the second mode of operation. At block 560, a second arithmetic result is determined based on the second operand, and a third arithmetic result is determined based on the third operand. The results can be provided to result register 126.

A single arithmetic unit including only one exponent and mantissa datapath that can execute a single operation in one mode, can be configured to execute two single-precision operations simultaneously in another mode, with substantially minimal additional cost and device area.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

For example, generic multiply, multiply-accumulate, and add operations can include variations such as multiply-add, negate multiply add, multiply subtract, and subtract. Implementation details such as the number of pipeline stages and how and when the correction value is applied are illustrated for the purpose of example, and skilled artisans will appreciate that methods disclosed can be implemented in other ways. Furthermore, the methods are applicable to other arithmetic devices and are not limited to floating-point arithmetic devices.

An arithmetic processing unit, such as FMAM 110, can receive two multiply operands and one addition operand, but the methods disclosed herein can be applied to other arithmetic processing units with a different number of multiplication and addition datapaths. Whereas FMAM 110 can support single, double, extended, and packed single-precision number formats, other formats or variations of these formats can be supported. Other arithmetic operations such as divide, square root, and transcendental operations may also be supported by FMAM 110.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
receiving a first input value at a multiply-addition module;
in response to determining a mode of operation of the multiply-addition module is a first mode:
determining a first operand based on the first input value; and
determining a first arithmetic result based on the first operand value; and
in response to determining the mode of operation of the multiply-addition module is a second mode:
determining a second operand based on a first portion of the first input value;
determining a third operand based on a second portion of the first input value;
determining a second arithmetic result based on the second operand value; and
determining a third arithmetic result based on the third operand value.

2. The method of claim 1, further comprising:
receiving a second input value at the multiply-addition module;
in response to determining the mode of operation of the multiply-addition module is the second mode:
determining a fourth operand based on a first portion of the second input value;
determining a fifth operand based on a second portion of the second input value;
wherein determining the second arithmetic result comprises determining the second arithmetic result based on the fourth operand value; and
wherein determining the third arithmetic result comprises determining the third arithmetic result based on the fifth operand value.

3. The method of claim 2, wherein determining the second arithmetic result comprises multiplying the second operand by the fourth operand.

4. The method of claim 3, wherein determining the third arithmetic result comprises multiplying the third operand by the fifth operand.

5. The method of claim 2, wherein:
determining the second arithmetic result comprises using the second operand to determine a first set of partial products and determining the second arithmetic result based on the first set of partial products; and
determining the third arithmetic result comprises using the third operand to determine a second set of partial products and determining the second arithmetic result based on the second set of partial products.

6. The method of claim 5, wherein:
determining the second arithmetic result comprises using the second input value to determine the first set of partial products; and
determining the third arithmetic result comprises using the second input value to determine the second set of partial products.

7. The method of claim 1, wherein:
the first input value is an N-bit value, where N is an integer;
the first operand is an N-bit value;
the second operand is an M-bit value;
the third operand is a P-bit value, where P plus M is less than N.

8. The method of claim 1, wherein:
determining the second arithmetic result comprises receiving an output value from the multiply-addition module and determining the second arithmetic result based on a first portion of the output value; and
determining the third arithmetic result comprises determining the third arithmetic result based on a second portion of the output value.

9. A method, comprising:
receiving a first value at a multiply-addition module in response to a first instruction;
in response to determining the first instruction is associated with a first precision type [double precision]:
determining the first value represents a single operand; and
determining a first arithmetic result based on the single operand; and
in response to determining the first instruction is associated with a second precision type [single precision]:
determining the first value represents a first plurality of operands comprising a first operand and a second operand;
determining a second arithmetic result based on the first operand; and
determining a third arithmetic result based on the second operand.

10. The method of claim 9, further comprising:
receiving a second value at the multiply-addition module;
in response to determining the first instruction is associated with a second precision type [single precision]:
determining the second value represents a second plurality of operands comprising a third operand and a fourth operand;
wherein determining the second arithmetic result comprises determining the second arithmetic result based on the third operand value; and
wherein determining the third arithmetic result comprises determining the third arithmetic result based on the fourth operand value.

11. The method of claim 10, wherein determining the second arithmetic result comprises multiplying the first operand by the third operand.

12. The method of claim 11, wherein determining the third arithmetic result comprises multiplying the second operand by the fourth operand.

13. The method of claim 10, wherein:
determining the second arithmetic result comprises using the first operand to determine a first set of partial products and determining the second arithmetic result based on the first set of partial products; and
determining the third arithmetic result comprises using the second operand to determine a second set of partial products and determining the second arithmetic result based on the second set of partial products.

14. The method of claim 13, wherein:
determining the second arithmetic result comprises using the second value to determine the first set of partial products; and
determining the third arithmetic result comprises using the second value to determine the second set of partial products.

15. The method of claim 9, wherein:
the first value is an N-bit value, where N is an integer;
the first operand is an M-bit value;
the second operand is a P-bit value, where P plus M is less than N.

16. The method of claim 9, wherein:
determining the second arithmetic result comprises receiving an output value from the multiply-addition module and determining the second arithmetic result based on a first portion of the output value; and
determining the third arithmetic result comprises determining the third arithmetic result based on a second portion of the output value.

17. A device comprising:
a first register configured to store a first input value;
a multiply-addition module comprising:
a first input configured to receive a mode indicator signal;
a second input coupled to the first register;
an output, wherein the multiply-addition module is configured to:
in response to the mode indicator signal indicating a first mode:
determining a first operand based on the first input value; and
provide a first arithmetic result at the output based on the first operand; and
in response to the mode indicator signal indicating a second mode:
determining a second operand based on a first portion of the first input value;
determining a third operand based on a second portion of the first input value;
determining a second arithmetic result based on the second operand; and
provide a third arithmetic result at the output based on the third operand.

18. The device of claim 17, further comprising:
a second register configured to store a second input value; and
wherein the multiply-addition module includes a third input coupled to the second register and is configured to:
in response to in response to the mode indicator signal indicating the second mode:
determine a fourth operand based on a first portion of the second input value;
determine a fifth operand based on a second portion of the second input value;
provide the second arithmetic result at the output based on the fourth operand; and
provide the third arithmetic result at the output based on the fifth operand.

19. The device of claim 18, wherein the multiply-addition module is configured to determine the second arithmetic result comprises multiplying the second operand by the fourth operand.

20. The device of claim 18, wherein:
the first input value is an N-bit value, where N is an integer;
the first operand is an N-bit value;
the second operand is an M-bit value; and
the third operand is a P-bit value, where P plus M is less than N.
